(19) United States
(12) Patent Application Publication
(10) Pub. No.: US 2007/0085298 A1
(43) Pub. Date: Apr. 19, 2007

(54) Bicycle improved with two front wheels

(76) Inventor: Jose P. Balajadia, New York, NY (US)

Correspondence Address: Jose P. Balajadia, Apt. 3J, 61-15 98th Street, Rego Park, NY, 11374, US

(21) Appl. No.: 11/253,335

(22) Filed: Oct. 19, 2005

(51) Int. Cl. B62K 7/00

(52) U.S. Cl. 280/282

(57) ABSTRACT

The balance of a bicycle is obtained by having two front wheels instead of one. The two front wheels are set apart but are connected by the same controller arm at the shoulders. The controller arm is a tube 1 inch in diameter and 18 inches long. The controller arm is attached at the middle to the bottom of the steerer tube and at the top of the steerer tube are attached the left and right handles. At both ends of the controller arm are the shoulders of the two pairs of forks for the two wheels. As is usual, the two front wheels are turned by using the handle bars.

### CROSS REFERENCE TO RELATED APPLICATION

Not Applicable.

### STATEMENT REGARDING FEDERALLY SPONSORED RESEARCH OR DEVELOPMENT

Not Applicable.

### REFERENCE TO SEQUENCE LISTING, TABLE, OR A COMPUTER PROGRAM LISTING COMPACT DISC APPENDIX

Not Applicable.

### BACKGROUND OF THE INVENTION

This invention pertains to a bicycle with two front wheels instead of a single wheel in front; and it includes all other vehicles with two front wheels. Vehicles resulting after the improvement are included.

There is only one important prior art relevant to this invention namely a bicycle of any kind which includes Balajadia's bicycle covered by patent # U.S. Pat. No. 6,394,478 B1 dated May 28, 2002. Balajadia's bicycle is compact, only 40 inches long, and front and back wheels of 12 inches in diameter.

Bicycles are prone to accidents and are unstable to ride.

No other patentability search was made regarding this invention.

It is the object of this invention to make the bicycle less prone to accidents and more stable to ride in. The two front wheels makes the bicycle more stable and less prone to accidents. Secondly, a left and right swivel wheel in the rear end makes the bicycle stable.

### BRIEF SUMMARY OF THE INVENTION

The two front wheels makes the bicycle less dangerous and safer to ride in. The rider doesn't have to put down his feet to support him from falling because the two wheels in front makes the bicycle more stable. The back wheel may be changed in size to increase or decrease its speed.

### BRIEF DESCRIPTIONS OF THE SEVERAL VIEWS OF THE DRAWING

FIG. 1 is a side view of Balajadia's bicycle, a prior art.

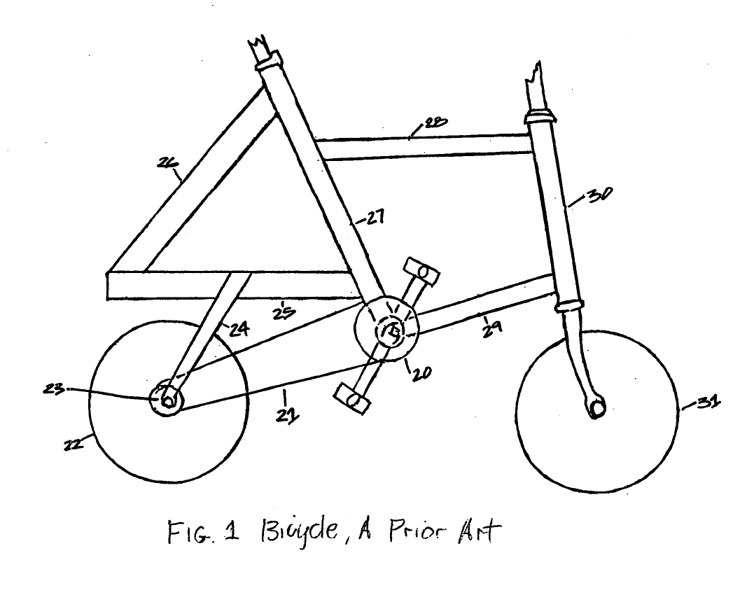

FIG. 2 is a front elevation of the two wheels showing the controller arm connected to the bottom of the steerer tube.

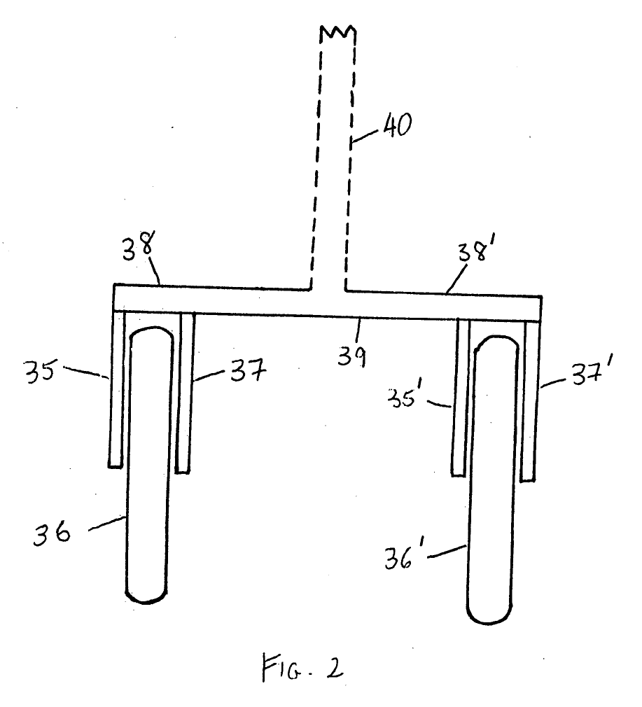

FIG. 3 is a side view of the rear end of Balajadia's bicycle and a front end in perspective showing the two wheels.

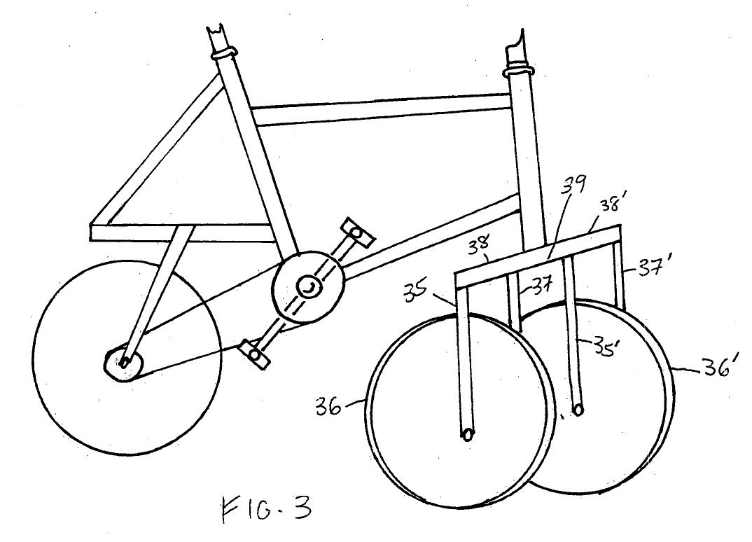

### DETAILED DESCRIPTION OF THE INVENTION

The invention is: 1. Vehicles resulting after improving the front end of a bicycle wherein such improvement comprises at least two front wheels of all kinds and of all sizes, swivel or not swivel, for better stability. 2. Vehicles resulting after improving the rear end of a bicycle comprising permanently or detachable, attaching at least a passenger seat, a freight container or an equipment with at least one wheel, i.e. bicycle wheel, scooter wheel, roller skate wheel, in-line skate wheel, etc., of all sizes, swivel or not swivel, for better operation. 3. Vehicles resulting after improving the front end and the rear end of a bicycle comprising at least one wheel, i.e. swivel bicycle wheel, scooter wheel swivel or not swivel, roller skate wheel swivel or not swivel, in-line skate wheel swivel or not swivel, etc., and permanently or detachable, attaching at least a passenger seat, a freight container, an equipment with at least one wheel, i.e. bicycle wheel, scooter wheel, roller skate wheel, in-line skate wheel, etc., swivel or not swivel, for better operation.

The preferred embodiment is 1, this is how it is made: the two front wheels are in their own forks 18 inches apart attached to the bottom of a controller arm. The controller arm which is a piece of 1 inch diameter pipe tube, 18 inches long and is attached in the middle to the bottom of the steerer tube. The two shoulders of the two pairs of forks are included at both ends of the controller arm. The left and right handles are attached to the top of the steerer tube.

Thus the reader will see that the tricycle formed is more stable and one can ride it even if one could not ride a bicycle. Millions of people of all ages, men or women can use this vehicle. Other unnamed vehicles are possible with two front wheels, ie: wheelchair, hand or feet operated, scooter or roller wheels, can be made into a scooter sitting down, and others.

While my above description contains many specificities, these should not be construed as limitations on the scope of the invention, but rather as an exemplification of one preferred embodiment thereof. Many other variations are possible. For example: 1. the two front wheels may be bicycle wheels of all sizes, swivel or not swivel, 2. the two front wheels may be scooter wheels of all sizes, swivel or not swivel, 3. the two front wheels are roller skate wheels, in-line skate wheels, etc., of all sizes, swivel or not swivel, 4. the two front wheels of claim 1, are running on rails or tracks, 5. other wheels of all sizes, of all kinds, swivel or not swivel, 6. the two front wheels of claim 1 include a rear wheel which is smaller, or the same, or bigger in diameter than the two front wheels, 7. the rear wheel may be rotated by a battery powered motor, 8. the rear wheel may be powered by a combination of pedaling and battery powered motor, 9. The rear wheel may be rotated by means of a fuel fed engine, 10. the rear wheel may be rotated by a combination of pedaling and a fuel led engine, 11. permanent or detachable attaching at least a passenger seat, a freight container, an equipment with at least one wheel, 12. with two front wheels, the rear end is attached with at least one pair of a left and right swivel wheels attached anywhere in the body permanently or detachable, 13. the single front wheel is a bicycle wheel, with swivel, 14. the single front wheel wherein a bicycle swivel wheel is in place, of all sizes, swivel only, 15. the single wheel is a scooter wheel of all sizes, swivel or not swivel, 16. the single wheel is a roller skate wheel or an in-line skate wheel, of all sizes, swivel or not swivel, 17. the single front wheel may be any wheel of all sizes, swivel or not swivel, 18. with a single wheel, the rear and may be attached with at least a pair of left and right swivel wheel, 19. a bicycle may be attached at the rear end with at least one pair of a left and right swivel wheel anywhere in the body.

Accordingly, the scope of the invention should be determined not by the embodiments illustrated but by the appended claims and the legal equivalents.

I claim:

1. Vehicles resulting after improving the front end of a bicycle comprising at least two front wheels of any kind, i.e. bicycle wheels, scooter wheels, roller skate wheels, in-line skate wheels, etc., of all sizes, swivel or not swivel, for better stability.

2. Vehicles resulting after improving the rear end of a bicycle comprising permanently or detachable, attaching at least a passenger seat, a freight container or an equipment with at least one wheel, i.e. bicycle wheel, scooter wheel, roller skate wheel, in-line skate wheel, etc., of all sizes, swivel or not swivel, for better operation.

3. The rear end of claim 2, including means for pedaling and/or a battery operated motor rotating the rear wheel.

4. The rear wheel of claim 2, including means for pedaling and/or a fuel fed engine rotating the rear wheel.

5. The rear end of claim 3, including at least a pair of left and right side wheels, i.e. bicycle wheels, scooter wheels, roller skate wheels, in-line skate wheels, etc., of any size, swivel or not swivel supporting the rear end of the bicycle.

6. The rear end of claim 5, including means for pedaling and/or a battery operated motor rotating the rear wheel.

7. The rear end of claim 5, including means for pedaling and/or a fuel fed engine rotating the rear wheel.

8. Vehicles resulting after improving the front end and the rear end of a bicycle comprising at least one front wheel, i.e. swivel bicycle wheel, scooter wheel swivel or not swivel, roller skate wheel swivel or not swivel, in-line skate wheel swivel or not swivel, etc., and permanently or detachable, attaching at least a passenger seat, a freight container an equipment with at least one wheel, i.e. bicycle wheel, scooter wheel, roller skate wheel, in-line skate wheel, etc., swivel or not swivel, for better operation.

9. The rear end of claim 8, including means for pedaling and/or a battery operated motor rotating the rear wheel.

10. The rear end of claim 8, including means for pedaling and/or a fuel fed engine rotating the rear wheel.

11. The rear end of claim 9, including at least one pair of a left and right side wheels, of any kind, of any size, swivel or not swivel in partial support of the rear end.

12. The rear end of claim 11, including means for pedaling and/or a battery powered motor rotating the rear wheel.

13. The rear end of claim 11, including means for pedaling and/or a fuel fed engine rotating the rear wheel.
